(19) United States
(12) Patent Application Publication
(10) Pub. No.: US 2009/0089150 A1
(43) Pub. Date: Apr. 2, 2009

(54) SYSTEM AND METHOD FOR OPERATION MANAGEMENT OF LOGISTICS CENTER

(75) Inventors: Ki Baek Lee, Daejeon (KR); Ji Young Choi, Daejeon (KR); Sang Rak Lee, Daejeon (KR); Wan Seok Kim, Daejeon (KR); Jong Heung Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/189,260

(22) Filed: Aug. 11, 2008

(30) Foreign Application Priority Data
Sep. 28, 2007 (KR) 10-2007-0097955

(51) Int. Cl. G06Q 10/00

(52) U.S. Cl. 705/10

(57) ABSTRACT

The present invention relates to a system and a method for operation and management of a logistics center In a system for operation and management of a logistics center according to an exemplary embodiment of the present invention, the past patterns of product amount for a user's desired operation plan period is analyzed and product amount to be handled in a predetermined unit by the logistics center is calculated, on the basis of the analysis result. Further, an operation plan about manpower needed for work in the logistics center is made on the basis of the calculated product amount of interest and basis information for manpower operation determined by a user. Thereafter, it is monitored whether corresponding work is on the operation plan that is made, and then at least one of the monitored results is provided to the user. Accordingly, it is possible to efficiently operate manpower needed in the logistics center, and to variously adjust and newly make a variety of work plans.

### CROSS-REFERENCE TO RELATED APPLICATION

This application claims priority to and the benefit of Korean Patent Application No. 10-2007-0097955 filed in the Korean Intellectual Property Office on Sep. 28, 2007, the entire contents of which are incorporated herein by reference.

### BACKGROUND OF THE INVENTION

(a) Field of the Invention

The present invention relates to a system and a method for operation management. More particularly, the present invention relates to a system and a method of operation management of a logistics center.

The present invention was designed from a work supported by the Postal Technology R&D program of MKE/IITA [2006-X-001-02, Development of Real-Time Postal Logistics System].

(b) Description of the Related Art

A logistics center, a physical distribution facility that collects finished 20 products from various factories and manages the distribution for demand and supply, controls transport time and the total stock and collects information of demand.

That is, the ordered products have been directly transported from a factory to a delivery center to serve order-and-delivery for clients in the past, but factory product warehouses for demanded products have been located at strategic areas for physical distribution to smoothly provide products for the demand market as efficient transport, economy of scale, and globalization are required.

In detail, the logistics center is a distribution hub that sorts, handles, and delivers products collected from a plurality of receiving stations, to n-number of zones distributed all over the country. Therefore, the logistics center plays an important role in the entire process, such as collection of products, transfer of the products in the logistics center, sorting, transport between logistics centers, dispatching and delivery. Accordingly, it is required to employ a large amount of equipment and manpower over time.

However, in the operation of manpower in the logistics center, a foreman disposes related manpower to each position on the basis of information about the amount of the past products handled (i.e. the tendency of products handled) and the experience in operation of manpower, and then evaluates the operation of manpower or is evaluated.

Further, computer systems as a unit for managing the amount of products and the manpower are used. However, specific systems for managing the amount of products and the manpower have been developed for each process in the computer systems. That is, there is a system for product collection, a system for transfer in the logistics center, a system for sorting, etc.

For this reason, data frequently does not coincide between internal systems for each process, and it is practically difficult to make a work plan for the amount of the products involved in real time due to differences in the conditions of the logistics center (e.g. the available work time and the time required for work). Further, it is difficult to calculate needed manpower from a manual-work plan based on the amount of products handled in the past.

In addition, because a contract of employment should be held for several months for the characteristics in common operation of manpower once the contract is made, it takes a lot of time and cost to correct the inefficient input of manpower.

A method of accurately estimating how much an output schedule for manufacturing products will be delayed has been known in the related art, but the method is not helpful to efficiently operate manpower in a logistics center.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method of operation management of a logistics center having advantages of efficiently operating manpower needed in the logistics center.

According to an aspect of the invention a system for operation and management of a logistics center includes: a product amount detecting module that analyzes past patterns of product amount for a desired operation plan period and then calculates product amount to be handled in a predetermined unit by the logistics center, on the basis of the analysis result a manpower operation planning module that makes at least one operation plan regarding manpower needed for work in the logistics center, on the basis of the calculated product amount of interest and basis information for manpower operation determined by a user; and an execution monitoring module that monitors whether corresponding work is on the plan that is made and then provides at least one of the monitored results to the user.

Further, a method of operating and managing a logistics center according to an aspect of the present invention includes: analyzing past patterns of product amount for a desired operation plan period; calculating a product amount to be handled in a predetermined unit by the logistics center, on the basis of the analysis result; making at least one operation plan regarding manpower needed for work in the logistics center, on the basis of the calculated product amount of interest and basis information for manpower operation determined by a user; and monitoring whether corresponding work is on the operation plan made and then providing at least one of the monitored results to the user.

According an exemplary embodiment of the present invention, the product amount that will be handled in a predetermined unit by the logistics center is estimated on the basis of experience in the field and the past patterns of product amount, and then an operation plan of manpower needed for a variety of work is made on the basis of the estimated information. Thereafter, it is monitored whether the logistics center is operated as planned and then the result is provided to a user or coped with immediately.

Accordingly, it is possible to efficiently operate manpower needed in the logistics center, and to variously adjust and newly make a variety of work plans.

### BRIEF DESCRIPTION OF THE DRAWINGS

FIG. 1 is a conceptual diagram illustrating the operation and working process of a logistics center where the present invention is applied.

FIG. 2 is a diagram illustrating the detailed configuration of an operation management system for a logistics center according to an exemplary embodiment of the present invention.

FIG. 3 is a flowchart sequentially illustrating the operating process of a product amount detecting module shown in FIG. 2.

FIGS. 4A and FIG. 4B are views showing a picture that displays estimated information about the amount of products provided to a user from the product amount detecting module shown in FIG. 2.

FIG. 5 is a flowchart sequentially illustrating the operating process of manpower operation planning module shown in FIG. 2.

FIG. 6A to FIG. 6D are views showing pictures that display information provided to a user from the manpower operation planning module shown in FIG. 2.

FIG. 7 is a flowchart sequentially illustrating the operating process of an execution monitoring module shown in FIG. 2.

FIG. 8A and 8B are views showing a picture that displays information to a user from the execution monitoring module shown in FIG. 2.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be further understood that the terms “comprises” and/or “comprising,” when used in this specification, specify the presence of stated components, but do not preclude the presence or addition of one or more other components, unless specifically stated. In addition, the terms “-er” “or”, “module”, and “block” described in the specification mean units for processing at least one function and operation, and can be implemented by hardware components or software components, and combinations thereof.

Further, the operation management of a logistics center is described in the following exemplary embodiments of the present invention, but the prevent invention is not limited thereto and may be applied to operation and management of other institutions and centers.

The operation and work of a logistics center where the present invention is applied is described first.

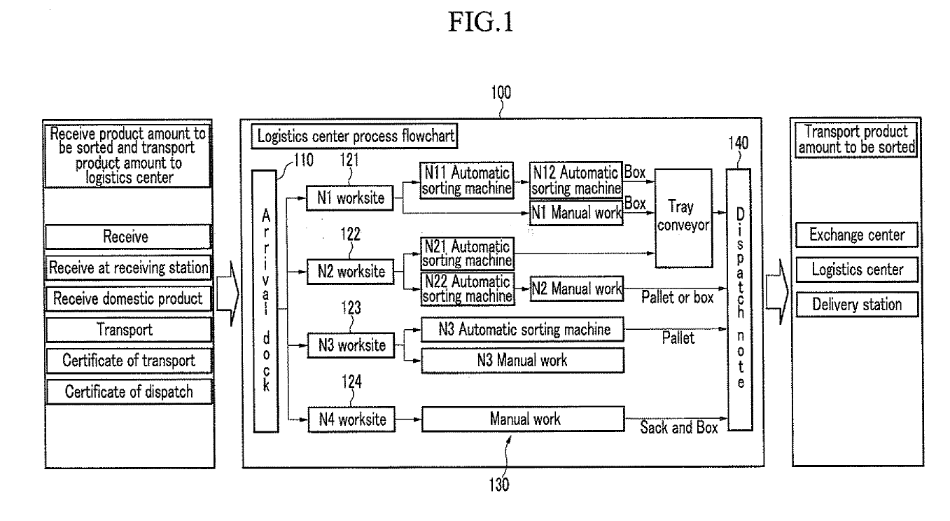

FIG. 1 is a conceptual diagram illustrating the operation and working process of a logistics center where the present invention is applied.

As shown in FIG. 1, in a logistics center 100, products received from each receiving station and domestic products are transported by transport trucks and unloaded to an arrival dock 110.

The unloaded products are classified by product_type, such as letter mail (big/small), parcel (standard/non-standard), and express mail, and then the classified products are sent to corresponding worksites 121, 122, 123, 124, in the logistics center 100.

Thereafter, in the logistics center 100, the products sent to the worksites 121, 122, 123, and 124 are sorted manually (130) or by automatic sorting machines and the sorted products are transferred to a dispatch dock 140. The transferred products are then loaded and transported to corresponding branches (e.g. other logistics centers, exchange centers, or delivery stations).

A operation management system of a logistics center according to an exemplary embodiment of the present invention (not shown) makes plans for operating manpower that will be inputted for various work (e.g. a plan of monthly staff demand and a plan of daily staff deployment), including unloading of products at the arrival dock 110, sorting of products at worksites 121, 122, 123, and 124, and loading of products at the dispatch dock 140.

In making plans, the operation management system makes operation plans depending on the period of operation plan (e.g. a month or a year). The present invention, however, is not limited to the above and may make other plans, depending on the period of operation plan, in addition to the operation plans.

Further, the operation management system of the logistics center lets a user know a variety of changes in conditions that occur while work is in process, on the basis of the plans made, or immediately copes with the changes.

An operation management system of a logistics center having the above configuration is described hereafter.

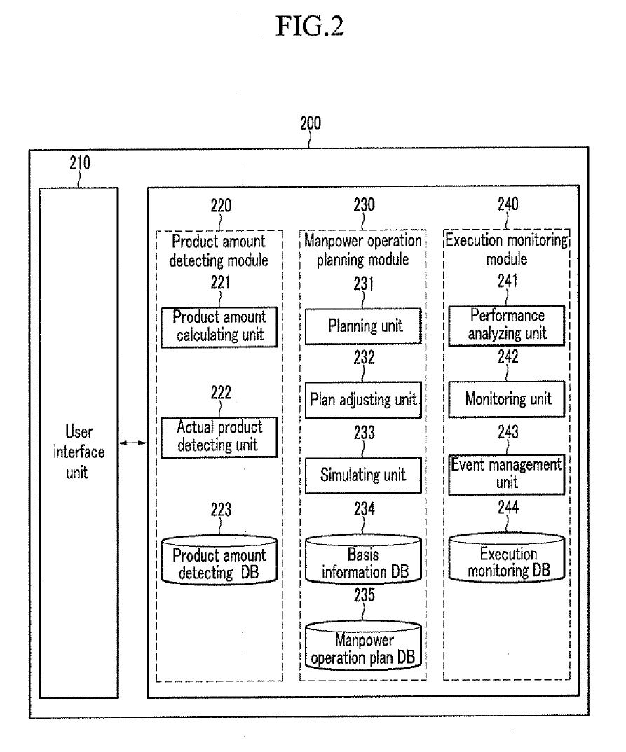

FIG. 2 is a diagram illustrating the detailed configuration of an operation management system for a logistics center according to an exemplary embodiment of the present invention.

As shown in FIG. 2, an operation management system 200 of a logistics center according to an exemplary embodiment of the present invention includes a user interface unit 210, a product amount detecting module 220, a manpower operation planning module 230, and an execution monitoring module 240.

Further, the product amount detecting module 220 includes a product amount calculating unit 221, an actual product detecting unit 222, and a product amount detecting DB 223.

The manpower operation planning module 230 includes a planning unit 231, a plan adjusting unit 232, a simulation unit 233, a basis information DB 234, and a manpower operation plan DB 235.

The execution monitoring module 240 includes a performance analyzing unit 241, a monitoring unit 242, an event management unit 243, and an execution monitoring DB 244.

In detail, the user interface unit 210 allows a user (a person concerned in the logistics center) to input information that is needed for operation management of the logistics center through a monitor, and provides results that are processed on the basis of the information by the modules 220, 230, and 240 to the user.

The product amount detecting module 220 estimates the amount of products that will be sorted in the logistics center (hereinafter referred to as “product amount”) on the basis of the information inputted through the user interface unit 210, and detects the actual products that are transported into the logistics center 100.

After receiving information about an inquiry period of the product amount handled and a corresponding logistics center from the user interface unit 210, the product amount calculating unit 221 analyzes the pattern of the past transported product amount from the received information. Characteristics in the past distribution of product amount, such as distribution of product amount by a day of the week/a date, distribution of product amount in a high-demand season, and distribution of product amount for each distribution center, are analyzed.

The product amount calculating unit 221 calculates a predetermined unit of product amount of interest from the analyzed results and, in an exemplary embodiment of the present invention, calculates product amount that will be handled, by product_types/dates/time_period for the next month.

Further, the product amount calculating unit 221 classifies product amount that is expected in the next year, by date/logistics center/product_type, on the basis of the calculated information.

The actual product detecting unit 222 checks the entire product amount by detecting products that are dispatched from at least one receiving station and other logistics centers and transported into the logistics center 100.

The product amount detecting DB 223 stores information about products calculated and analyzed by the product amount calculating unit 221 and the actual product detecting unit 222, including information inputted by the user interface unit 210.

The manpower operation planning module 230 makes a plan of monthly staff demand and a plan of daily staff deployment of manpower needed for operation of the logistics center, on the basis of the information about the product amount estimated by the product amount detecting module 220. Further, the plan is adjusted when a user requests change.

First, when a manpower operation basis information including one of work times by work shifts, types by work shifts, types of overtime work, automatic sorting equipment, working hours, and wages is inputted through the user interface unit 210, the planning unit 231 make plans of monthly staff demand and daily staff deployment for the next month by product_type/worksites/time_periods, on the basis of the inputted information and the information about management product amount previously estimated.

As described above, the planning unit 231 according to an exemplary embodiment of the present invention makes a plan of manpower operation for a basic unit, i.e., a month. However, the planning unit 231 may make a plan for other units, for example days set by a user at his/her discretion.

When a user requests change or modification of the estimated product amount by product_type/time_periods that is part of the information estimated by the product amount detecting module 220, the plan adjusting unit 232 adjusts the plan of daily staff deployment in accordance with the request.

Further, when the actual product amount that has arrived is largely different from the estimated product amount or the work is not processed as planned, the planning unit 232 adjusts the plan of daily staff deployment.

The simulation unit 233 periodically simulates the performance of the logistics center, the product amount transported into the logistics center, and the remaining work.

The basis information DB 234 stores information about bases needed for making a variety of plans, including the manpower operation basis information inputted through the user interface unit 210.

The manpower operation plan DB 235 stores the plans of monthly staff demand and daily staff deployment in the logistics center, adjusted daily staff deployment, and the result of simulation that are made by the manpower operation planning module 230.

The execution monitoring module 240 checks the performance of the logistics center and the real-time work process and monitors whether corresponding work is in process as planned. Thereafter, needed work is performed in accordance with the monitored result.

First, when information such as the sorting shift (sorting of dispatch, sorting of arrival) time and the available work time of the logistics center is inputted through the user interface unit 210, the performance analyzing unit 241 analyzes the performance of the logistics center on the basis of the inputted information.

That is, the performance analyzing unit 241 analyzes the performance per hour for each product_type by analyzing the available work time of the logistics center and the results made by each automatic sorting machine.

The monitoring unit 242 monitors the product amount transported into the logistics center and the real-time work process, on the basis of the analyzed result.

The event management unit 243 checks whether an event (e.g. impossible to handle within a desired time), which is at least one result previously defined by a user, is included in the monitored result. Thereafter, the event management unit 243 directly lets the user know about the checked event using a predetermined message or immediately copes with the event.

The execution monitoring DB 244 stores the analyzed performance of the logistics center, the monitored result of the logistics center, and information about the event, in addition to the information inputted through the user interface unit 210.

The operation management system 200 of the logistics center according to an exemplary embodiment of the present invention, as described above, estimates the product amount that will be handled in a predetermined unit by the logistics center, on the basis of experience in the field and the past pattern of product amount. Further, the operation plan of manpower needed for work in the logistics center, such as a plan of monthly staff demand and a plan of daily staff deployment, is made from the estimated information.

Furthermore, the operation management system 200 monitors whether the logistics center is operated as planned and then directly lets a user know about the result, or immediately copes with the result.

Therefore, according to an exemplary embodiment of the present invention, it is possible to maximize the efficiency in the manpower operation of the logistics center. Further, it is possible to variously adjust or newly make a variety of plans needed for the operation and management of the logistics center because the plans are made in accordance with the basis information inputted by a user.

A method of operating and managing a logistics center according to an exemplary embodiment of the present invention is described hereafter, on the basis of the operation management system 200 of the logistics center having the above configuration.

The operating process of the product amount detecting module 220 of the modules 220, 230, and 240 in the operation management system 200 is first described hereafter.

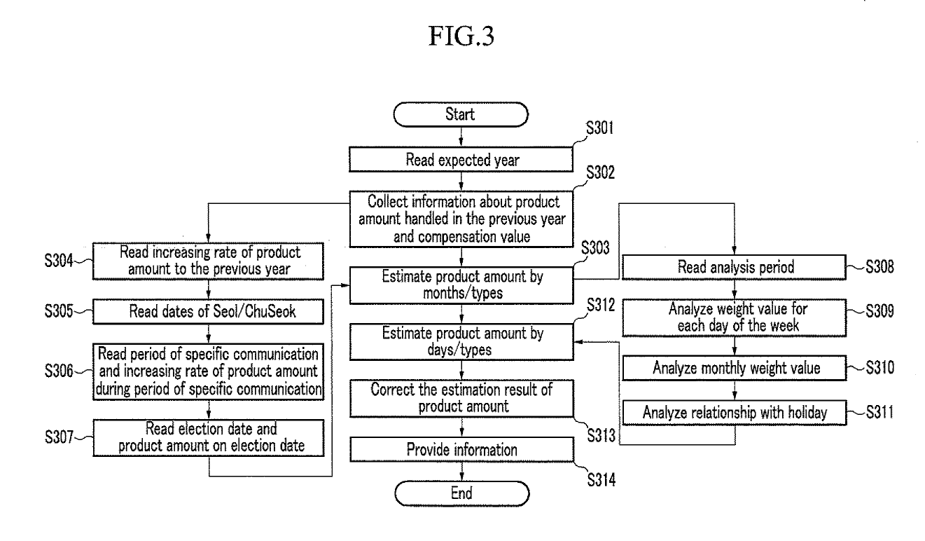

FIG. 3 is a flowchart sequentially illustrating the operating process of the product amount detecting module shown in FIG. 2.

As shown in FIG. 31 the product amount calculating unit 221 of the product amount detecting module 220 receives an expected year from a user through the user interface unit 210 (S301).

The product amount calculating unit 221 then collects information about the product amount handled in the previous year with respect to the inputted expected year and provides the collected information to the user (S302). Thereafter, a qualitative compensation value for the provided information is inputted through the user interface unit 210 (S302).

For reference, the qualitative compensation value is information that is inputted through the user interface unit 210 by a person in charge of product amount estimation in the logistics center. The qualitative compensation value includes any one of the increasing rate to the previous year (increasing rate of the product amount in the expected year compared to the previous year), the date of Seolai/ChuSeok(big holidays), the specific period of management, the increasing rate of the product amount in a period of specific management (postal special period, increasing rate of product amount in the postal special period), and the election date and the number of products (increasing rate of the product amount on the election date).

In detail, the increasing rate of the product amount compared to the previous year (S304), the date of Seolal/ChuSeok (S305), the postal special period and the increasing rate of product amount in the postal special period (S306), and the election date and the product amount on the election date (S307), which are qualitative compensation values, are inputted to the product amount calculating unit 221 by the user.

Thereafter, the product amount calculating unit 221 estimates the product amount by product_type/month of the logistics center, on the basis of the inputted information (S303).

Further, the product amount calculating unit 221 generates a statistical weight value on the basis of the estimated information.

For reference, the statistical weight value is a distribution weight value for each component based on the result obtained by analyzing data of the product amount handled. This is a method for increasing a relationship with the product amount handled by product_type/date and includes any one of a weight value by day of the week having an effect on the pattern of product amount received, a monthly weight value (weight value for days in a month, such as 1^{st} to 5^{th} days, 6^{th} to 10^{th} days, 11^{th} to 15^{th} days, 20^{th} to 25^{th} days, 25^{th} to 30^{th} days), and a weight value for a relationship with holidays (when a holiday is included in a week).

In detail, the product amount calculating unit 221 receives the analysis period of the data of the product amount handled through the user interface unit 210 from the user (S308), and then analyzes the weight value by day of the week, on the basis of the received information (S309). Thereafter, the product amount calculating unit 221 analyzes the monthly weight value (S310).

Subsequently, the product amount calculating unit 221 analyzes the relationship with holidays (S311) and estimates the product amount by date/product_type, on the basis of the analyzed result (S312). The product amount calculating unit 221 reads compensation instructions for the final result and applies the instructions to the result (S313), and which is then provided to the user (S314).

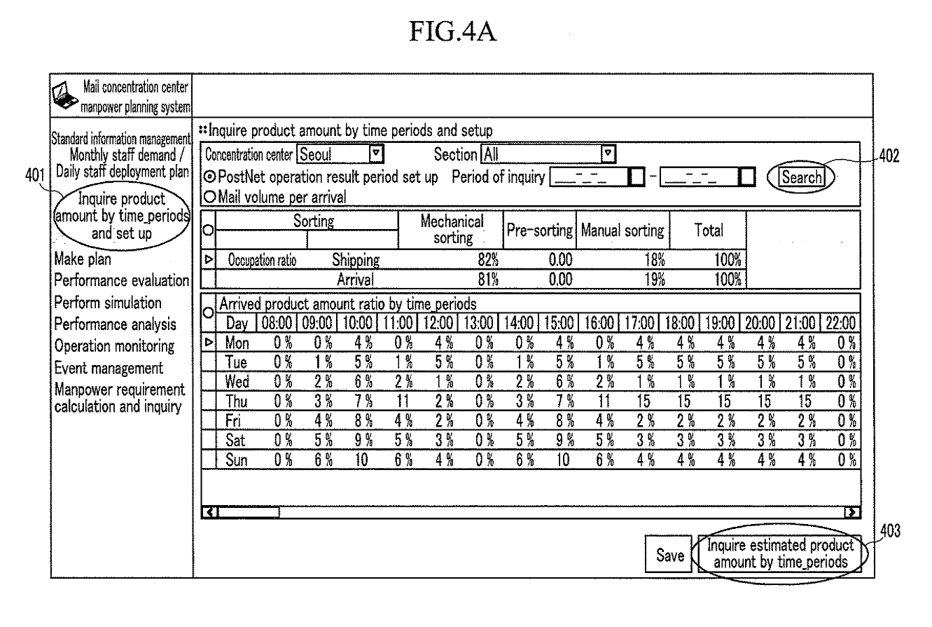

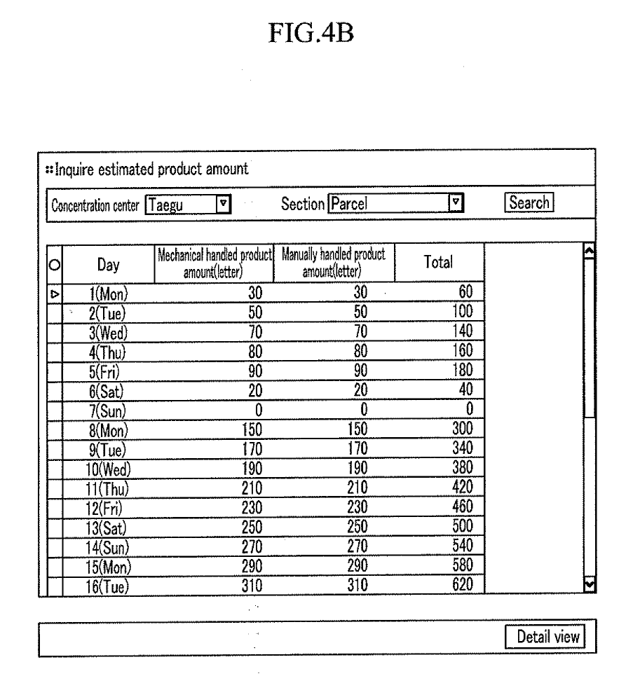

Information provided to the user from the product amount detecting module 220 is described hereafter, on the basis of the above operating process. FIGS. 4A and 4B show an example of display of the information.

FIGS. 4A and FIG. 4B are views showing pictures that display estimated information provided to a user from the product amount detecting module shown in FIG. 2.

As shown in FIG. 4A, when the user clicks “inquire product amount by time_period and setups 401 of the several menus in the picture provided by the product amount detecting module 220 through the user interface unit 210, the user interface unit 210 provides a picture for inputting information to the user.

Next, the user inputs information needed for inquiring about the product amount and setting up, such as logistics center, section, and period of inquiry, through the provided picture. When the user clicks “search” 402, the product amount calculating unit 221 searches the operation result for the period of inquiry and the rate of handled product amount by time_period that have been stored, and provides them to the user.

Subsequently, the user inquires about a ratio of mechanical work to manual work, a ratio of arrived product amount by time_period, etc., and then resets the values inquired about. Thereafter, when the user clicks “inquire estimated product amount by time_period” 403, the product amount calculating unit 221, as shown in FIG. 4B, provides the estimated product amount by days and the estimated product amount by time_period to the user through a picture for inquiring about the estimated product amount.

The operating process of the manpower operation planning module 230 in the operation management system 200 shown in FIG. 2 is described hereafter.

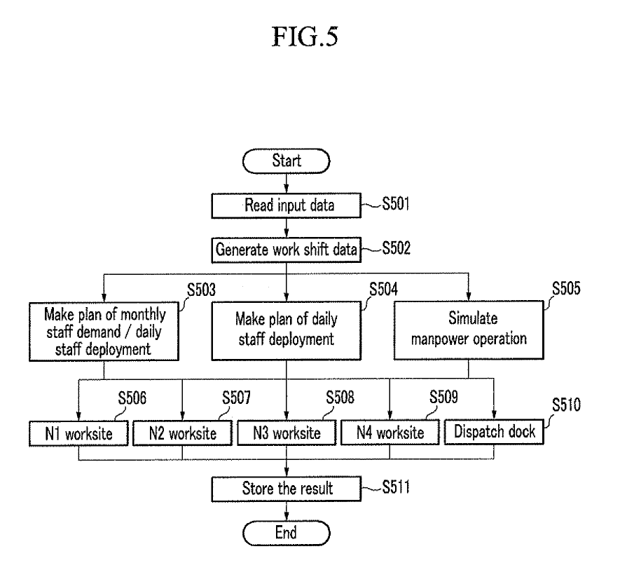

FIG. 5 is a flowchart sequentially illustrating the operating process of the manpower operation planning module shown in FIG. 2.

For reference, the operating process of the manpower operation planning module 230 according to an exemplary embodiment of the present invention is composed of reading information needed for making a plan of manpower operation from a corresponding DB, making a plan of manpower operation on the basis of the read information, and storing the plans and involved information to a corresponding DB.

In detail, as shown in FIG. 5, the planning unit 231 of the manpower operation planning module 230 reads information needed for making a plan of manpower operation from a corresponding DB (S501).

That is, the planning unit 231 reads information about product amount estimated in the next month and product amount expected on the day (domestic product amount and product amount that is being transported from the receiving station to the logistics center) from the product amount detecting DB 223.

Further, the planning unit 231 reads information about unit work/unit product amount and part-time work from the basis information DB 234 and also reads information about work and equipment from the manpower operation plan DB 235. Furthermore, the planning unit 231 reads information about the analysis of performance of the logistics center from the execution monitoring DB 244.

Thereafter, the planning unit 231 determines work shifts on the basis of the read information and then generates data about personnel expenses by work shifts and working hours (S502). The planning unit 231 determines work shifts according to the time of work start and working hours.

For reference, it is determined which one of the units 231, 232, and 233 makes which plan, depending on the product_types of plans made.

In detail, the planning unit 231 makes plans of monthly staff demand and daily staff deployment on the basis of the product amount estimated in the next month (S503), and the plan adjusting unit 232 makes a plan of daily staff deployment on the basis of the product amount estimated on the day (S504).

Further, the simulation unit 233 simulates the performance of the logistics center, the product amount transported in the logistics center, and remaining work, on the basis of the basis information for manpower operation.

In planning, the units 231, 232, and 233 make plans by at least one worksite (S506, S507, S508, S509, S510).

Thereafter, the manpower operation planning module 230 stores information of the plans made and information involved, such as members by time_period, members by worksites, members by work shifts, and handled/non-handled product amount, to a corresponding DB (S511).

That is, the manpower operation planning module 230 stores information about the plans of monthly staff demand, daily staff deployment, simulation, and the results to the manpower operation plan DB 235, and the plan of daily staff deployment adjustment and information involved to the execution monitoring DB 244.

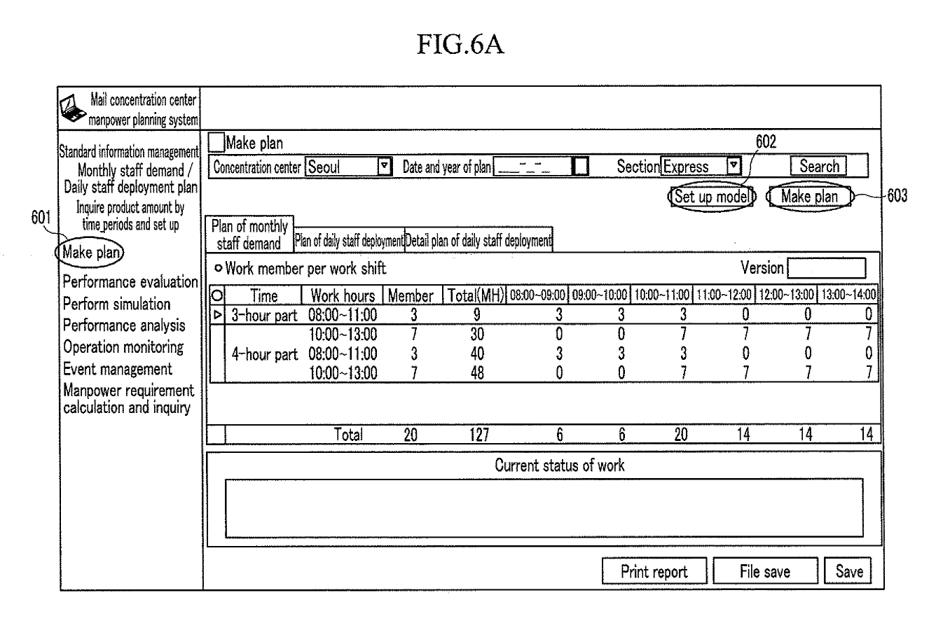

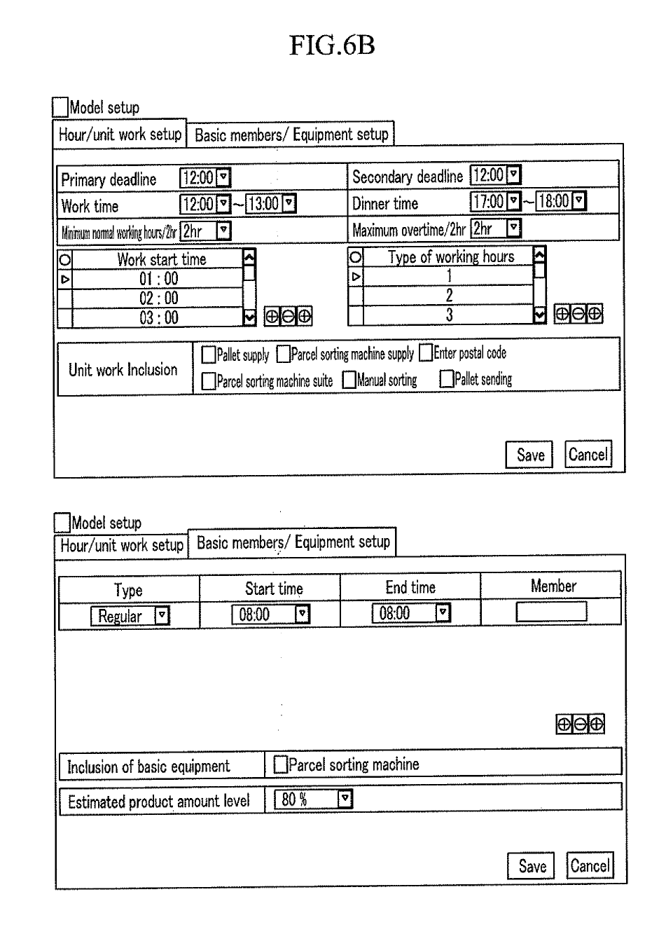

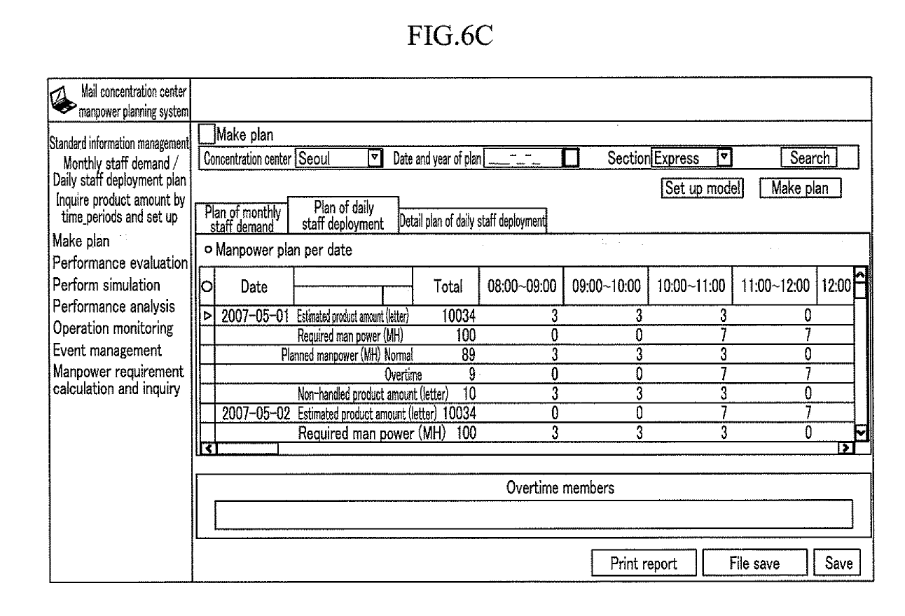

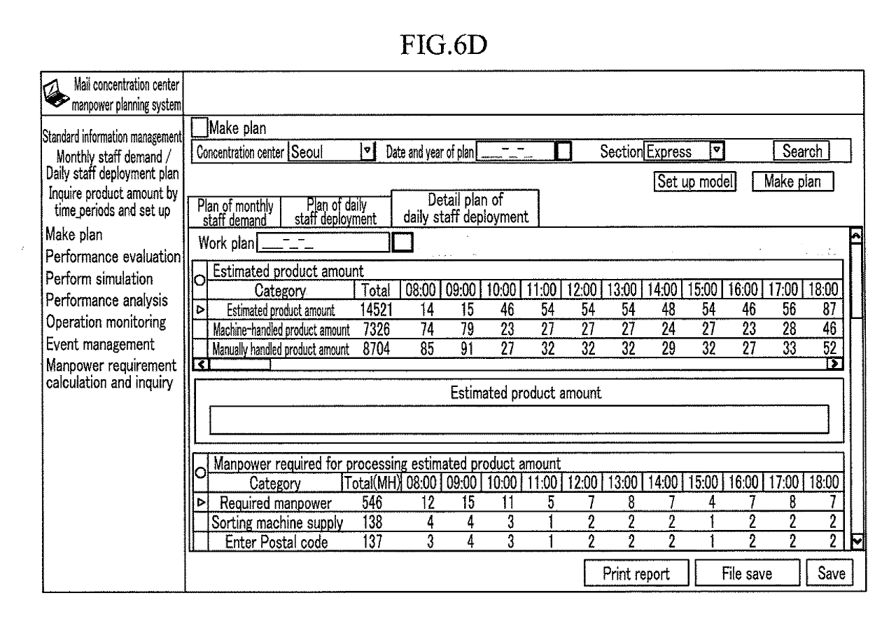

Information that is provided to the user from the manpower operation planning module 230 is described hereafter, on the basis of the above operating process. FIGS. 6A to D show an example of display of the information.

FIG. 6A to FIG. 6D are views showing pictures that displays information provided to a user from the manpower operation planning module shown in FIG. 2.

As shown in FIG. 6A, when the user clicks “make plan” 601 of the several menus in the picture provided by the manpower operation planning module 230 through the user interface unit 210, the user interface unit 210 provides a picture for inputting information needed for making a plan to the user. When a plan that has been made before exists, it is also provided.

Thereafter, the user inputs information such as logistics center of interest, date and year of the plan, and section, through the provided picture.

Subsequently, when the user clicks “set up model” 602 to make a new plan, the user interface unit 210 provides an information input picture needed for setting up the model to the user, as shown in FIG. 6B.

Therefore, the user inputs information, such as work finish time, lunch/dinner time, minimum normal working hours, maximum overtime, work start time, type of working hours, whether unit work is included, regular/public basic members, whether basic equipment (automatic sorting machine) is included, and level of estimated product amount that are used in making the plan, through the picture.

Further, when the user clicks “make plan” 603 after setting up the model, the manpower operation planning module 230 makes plans of monthly staff demand and daily staff deployment that are needed for operation of the logistics center, on the basis of the information previously inputted. Thereafter, the manpower operation planning module 230 provides the plans made to the user, as shown in FIG. 6A, FIG. 6C, and FIG. 6D.

In detail, the manpower operation planning module 230, as shown in FIG. 6A, provides information about members by work shifts who will normally work every day for the planned period, i.e., month or year, to the user.

Further, the manpower operation planning module 230, as shown in FIG. 6C, provides information about additional members who will work overtime, depending on the product amount, in addition to the normal members included in the plan of monthly staff demand.

That is, the manpower operation planning module 230 provides information such as estimated product amount by time_period, manpower needed for handling the estimated product amount at each time_period, pre-planned manpower, and product amount that will not be handled by the planned manpower (remaining work), which are planned for each date. Further, overtime manpower including the normal manpower included in the plan of monthly staff demand is provided with the planned manpower.

Further, the manpower operation planning module 230, as shown in FIG. 6D, displays the estimated product amount and the non-handled product amount by time_period, according to sorting of the product amount, and provides needed manpower and planned manpower by worksites.

The operating process of the execution monitoring module 240 of the operation management system 200 shown in FIG. 2 is described hereafter.

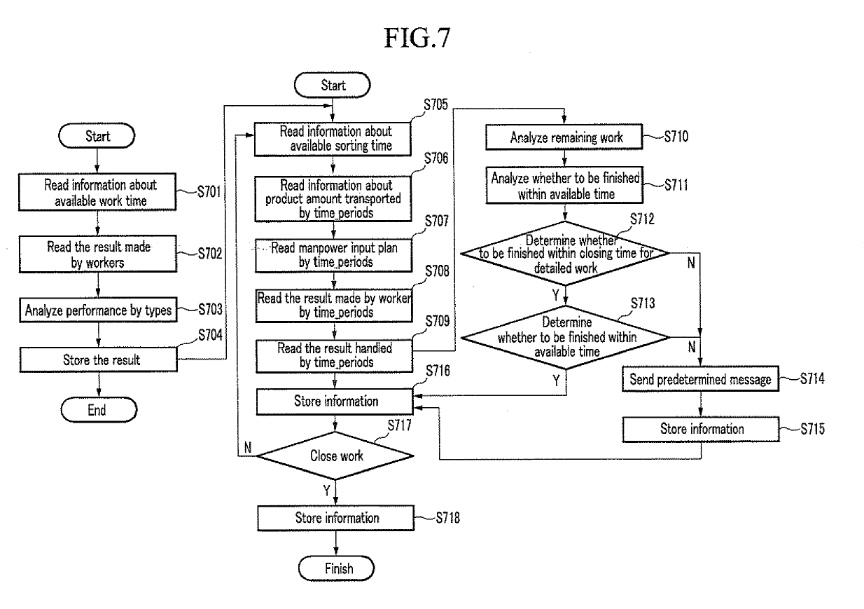

FIG. 7 is a flowchart sequentially illustrating the operating process of the execution monitoring module shown in FIG. 2.

For reference, the operating process of the execution monitoring module 240 according to an exemplary embodiment of the present invention is composed of reading data needed for monitoring the logistics center from a corresponding DB, monitoring the present state of the products that are being handled on the basis of the read data, and storing the monitored results to a corresponding DB.

In detail, as shown in FIG. 7, the performance analyzing unit 241 of the execution monitoring module 240 receives the available work time of the logistics center from the through the user interface unit 210 from the user (S701).

Further, the performance analyzing unit 241 collects the process results for each product_type with respect to the number of workers from the execution monitoring DB 244 to analyze the performance of each product_type (S702).

Thereafter, the performance analyzing unit 241 analyzes performance of each automatic sorting machine and each numbered machine, and the results made by manual sorting, on the basis of the collected data and received information (S703), and stores the analyzed data to the execution monitoring DB 244 (S704).

Subsequently, the monitoring unit 242 of the execution monitoring module 240 collects analysis information about the performance for each product_type and the available work time stored by the performance analyzing unit 241 (S705).

Further, the monitoring unit 242 collects real-time product amount information from the product amount detecting DB 223 (S706), and collects the plans of manpower input by time_period from the manpower operation plan DB 235 (S707)

Thereafter, the monitoring unit 242 receives the manpower input information that is practically inputted for each time_period from the user through the user interface unit 210 (S708), and acquires information about the results by time_period handled by the automatic sorting machine from an operating system of the automatic sorting machine (S709).

Subsequently, the event management unit 243 analyzes the acquired information about the product amount handled, remaining work, and analysis of performance (S710), and then analyzes whether the corresponding manpower can do the given work within the available work time on the basis of the analysis result (S711).

Further, the event management unit 243 determines whether the corresponding manpower can finish the given work within the closing time, for each detailed work, on the basis of the analysis result (S712).

When it is determined that the work could not be finished by the closing time, the event management unit 243 directly sends a message that is predetermined by the user (e.g. more manpower is needed because it is difficult to finish the given work by the closing time) to the user through the user interface unit 210 (S714).

In contrast, when it is determined that the given work could be finished within the closing time, the event management unit 243 determines whether the corresponding manpower can finish the given work within the available work time (S713).

As a result of the determining, when the given work could not be finished within the available work time, the event management unit 243 sends a predetermined message to the user through the user interface unit 210 (S714). Further, the event management unit 243 stores involved information to the execution monitoring DB 244 (S715).

On the other hand, when it is determined that the given work could be finished within the available work time, the monitoring unit 242 continuous works until the logistics center is closed (S716 and S717).

Further, when the work is finished, the monitoring unit 242 stores information, such as the results by time_period, into the execution monitoring DB 244 (S718).

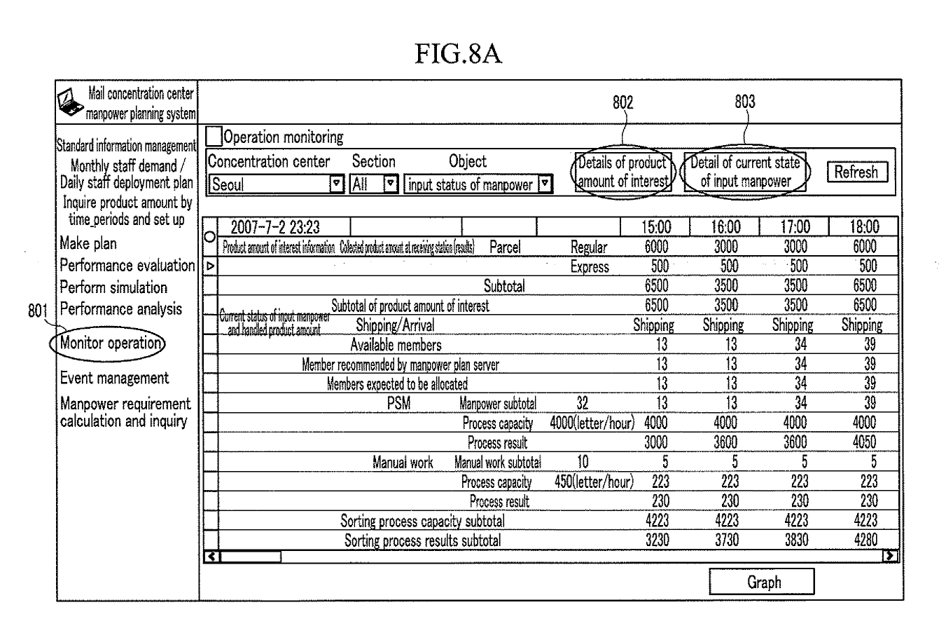

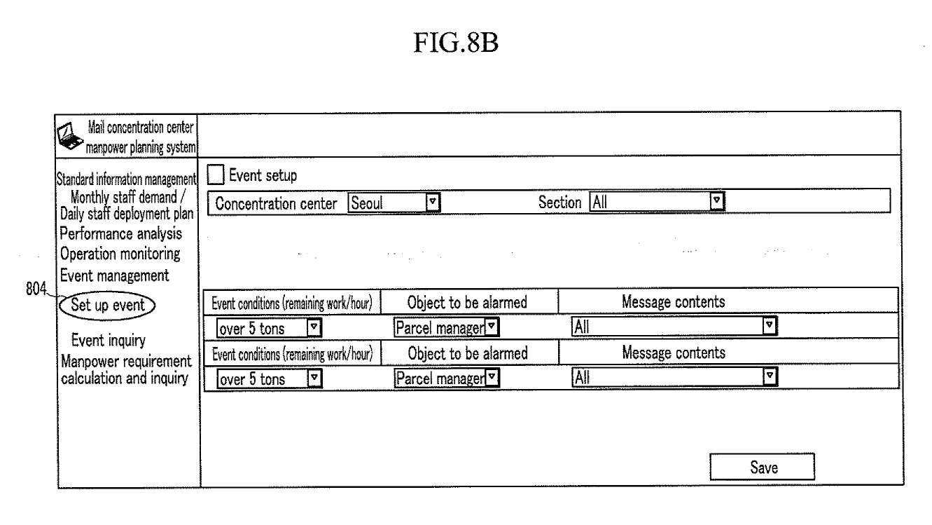

Information that is provided to the user by the execution monitoring module 240 is described hereafter, on the basis of the above operating process. FIGS. 8A to 8B show an example of display of the information.

FIG. 8A and FIG. 8B are views showing a picture that displays information to a user from the execution monitoring module shown in FIG. 2.

As shown in FIG. 8A, when the user clicks “operation monitoring” 801 of the several menus in a picture provided by the execution monitoring module 240 through the user interface unit 210, the user interface unit 210 provides a picture for inputting information to the user.

Thereafter, the user selects logistics center, section, and object to be monitored from the provided picture.

Subsequently, the user interface unit 210 provides information such as the product amount of interest acquired by the product amount module 220, the inputted manpower acquired by the manpower operation planning module 230, the performance by work, the result of sorting, the work efficiency, the remaining work, and the process of work, on the picture.

On the other hand, when the user clicks “details of product amount of interest” 802 of the several menus in the picture provided by the execution monitoring module 240 through the user interface unit 210, the user interface unit 210 collects product amount of interest from the receiving station, and then classifies, in detail, the product amount that is being transported to the logistics center, the product amount collected from the receiving station, the product amount that is sorted at another logistics center and being transported to the corresponding logistics center, and the product amount that has arrived at the logistics center, and provides the results to the user.

Thereafter, when the user clicks “detail of current state of input manpower 803 of the several menus in the picture, the user interface unit 210 provides the detailed current state of the input manpower according to the available members, the predetermined members by the manpower operation plan, and the results made by the workers, to the user.

Further, as shown in FIG. 8B, when the user clicks “event setup” 804 of the several menus in the picture provided by the execution monitoring module 240 through the user interface unit 210, the user interface unit 210 provides a picture for inputting information to the user.

Thereafter, the user inputs information such as event conditions, objects to be alarmed, and messages, for each logistics center and section through the provided picture. That is, it is registered which message would be sent to which receiver, in the event predetermined by the user.

As described above, the operation management system 200 of a logistics center according to an exemplary embodiment of the present invention can maximize the efficiency in manpower operation for each logistics center. Further, since the system makes plans and is operated according to the basis information inputted by a user, it is possible to variously adjust or newly make plans for operation and management of a logistics center.

The embodiment of the present invention described above is not implemented by only the method and apparatus, but it may be implemented by a program for executing the functions corresponding to the configuration of the exemplary embodiment of the present invention or a recording medium having recorded thereon the program. These implementations can be realized by the ordinary skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for operation management of a logistics center, comprising:
a product amount detecting module that analyzes past patterns of product amount for a desired operation plan period and then calculates product amount to be handled in a predetermined unit by the logistics center, on the basis of the analysis result;
a manpower operation planning module that makes at least one operation plan about manpower needed for work in the logistics center, on the basis of the calculated product amount of interest and basis information for manpower operation determined by a user; and
an execution monitoring module that monitors whether corresponding work is on the plan that is made and then provides at least one of the monitored results to the user.

2. The system of claim 1, wherein the product amount detecting module includes:
a product amount calculating unit that analyzes the past patterns of product amount when a user inputs any one of information about an inquiry period of a predetermined product amount handled and the logistics center, on the basis of the inputted information, and then calculates product amount to be handled in a predetermined unit in the logistics center on the basis of the analysis result; and
an actual product detecting unit that checks a product amount that is transported into the logistics center by detecting products that are delivered from at least one receiving station and another logistics center.

3. The system of claim 1, wherein the manpower operation planning module includes:
a planning unit that makes an operation plan including any one of a plan of monthly staff demand and a plan of daily staff deployment, for a predetermined unit, on the basis of the basis information for manpower to operation determined by the user and the calculated product amount of interest;
a plan adjusting unit that adjusts the operation plan that is made, when the user requests the plan adjusting unit to change one of the calculated product amount of interest, in accordance with instructions requested by the user; and
a simulation unit that simulates any one of performance of the logistics center, product amount that is transported into the logistics center, and remaining work.

4. The system of claim 3, wherein the plan adjusting unit adjusts the operation plan that is made, when a difference of the product amount transported into the logistics center from the calculated product amount of interest is above a predetermined value or corresponding work is not in the planned processes.

5. The system of claim 1, wherein the execution monitoring module includes:
a performance analyzing unit that analyzes performance per hour for each product_type of the logistics center when any one of available work time of the logistics center and sorting shift (sorting of dispatch, sorting of arrival) time is inputted by the user, on the basis of the inputted information;
a monitoring unit that monitors processes of work for each product and product amount transported into the logistics center, on the basis of the analyzed performance; and
an event management unit that checks whether an event, which is at least one result previously defined by a user, is included in the monitored result, and then provides the details of the event to the user.

6. The system of claim 1, wherein the basis information for manpower operation includes any one of work times by work shifts, types of work shifts, types of overtime work, automatic sorting equipment, working hours, and wages.

7. A method of operating and managing a logistics center, comprising:
analyzing past patterns of product amount for a desired operation plan period;
calculating product amount to be handled in a predetermined unit by the logistics center, on the basis of the analysis result;
making at least one operation plan about manpower needed for work in the logistics center, on the basis of the calculated product amount of interest and basis information for manpower operation determined by a user; and
monitoring whether corresponding work is on the operation plan that is made and then providing at least one of the monitored results to the user.

8. The method of claim 7, wherein the making of an operation plan includes:
receiving basis information for manpower operation including any one of work times by work shifts, types of work shifts, types of overtime work, automatic sorting equipment, working hours, and wages, from the user; and
making an operation plan including any one of a plan of monthly staff demand and a plan of daily staff deployment, in a predetermined unit, on the basis of the inputted basis information for manpower operation and the calculated product amount of interest.

9. The method of claim 7, wherein the providing of at least one of the monitored results to the user includes:
analyzing performance per hour for each product_type of logistics center when any one of available work time of the logistics center and sorting shift time is inputted by the user on the basis of the inputted information; and
monitoring processes of work for each product and product amount transported into the logistics center, on the basis of the analyzed performance.
